(19) United States
(12) Patent Application Publication
(10) Pub. No.: US 2010/0182311 A1
(43) Pub. Date: Jul. 22, 2010

(54) Mobile terminal for generating 3-dimensional image

(75) Inventor: Keon Ho Kim, Bucheon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/657,344

(22) Filed: Jan. 19, 2010

(30) Foreign Application Priority Data
Jan. 19, 2009 (KR) 10-2009-0004002

(51) Int. Cl. G06T 15/00; H04N 5/228

(52) U.S. Cl. 345/419; 348/222.1; 348/E05.031; 455/550.1

(57) ABSTRACT

A mobile terminal can generate a 3-dimensional image by using a space code. The mobile terminal includes a light source unit that projects pattern lights to an object; a camera unit that picks-up images of the object exposed to the pattern lights; and a control unit that generates a space code from at least one of images picked up the camera, generates a space code image based on the space code, converts 2-dimensional coordinates of the space code image to 3-dimensional coordinates using a 3-dimensional coordinate equation, and generates a depth image using the 3-dimensional coordinates.

### CROSS-REFERENCE TO RELATED APPLICATION(S) AND CLAIM OF PRIORITY

The present application is related to and claims priority to an application entitled “MOBILE TERMINAL FOR GENERATING 3-DIMENSIONAL IMAGE” filed in the Korean Intellectual Property Office on Jan. 19, 2009 and assigned Serial No. 10-2009-0004002, the contents of which are incorporated herein by reference.

### TECHNICAL FIELD OF THE INVENTION

The present invention relates to a mobile terminal and, in particular, to a 3-dimensional image generation method for a mobile terminal by using a space code.

### BACKGROUND OF THE INVENTION

With the increasingly widespread use of mobile communication technologies, the mobile phone (mobile terminal) is becoming an essential element in our life today and integrating more and more supplementary functions.

Among them, the digital camera function allows the user to pick up pictures and record videos without additional digital camera and camcorder. The digital camera module of the mobile phone has developed ceaselessly to the extent equal to the dedicated digital camera in resolution and other functional performance.

Meanwhile, with the increasing demand on the use of three-dimensional images, various 3-dimensional imaging technologies have been developed. A three-dimensional image gives the viewer depth perception so as to be used as useful data in various visual applications. However, since the current 3-dimensional imaging technologies have been developed in consideration of the use in high performance computer system, it is not adequate for the capability-constrained mobile phone. Accordingly, there is a need to develop a three-dimensional image generation method for the capability constrained mobile phones.

### SUMMARY OF THE INVENTION

To address the above-discussed deficiencies of the prior art, it is a primary object to provide a mobile terminal that is capable of creating a three-dimensional image.

In accordance with an exemplary embodiment of the present invention, a mobile terminal includes a light source unit that projects pattern lights to an object; a camera unit that picks up images of the object exposed to the pattern lights; and a control unit that generates a space code from at least one of images picked up the camera, generates a space code image based on the space code, converts 2-dimensional coordinates of the space code image to 3-dimensional coordinates using a 3-dimensional coordinate equation, and generates a depth image using the 3-dimensional coordinates.

In some embodiments, the light source unit can project a gradation light of that brightness varies gradually in a direction.

In some embodiments, the camera unit can pick-up the image of the object whenever the object is exposed to the pattern light projected by the light source unit.

In embodiments, the control unit calculates a distance from the object using the 3-dimensional coordinates and a camera matrix.

In some embodiments, the mobile terminal further includes a radio frequency unit which receives data of the 3-dimensional coordinate conversion equation.

In accordance with another exemplary embodiment of the present invention, a 3-dimensional image generation method of a mobile terminal includes projecting different types of pattern lights to an object in series, picking up a predetermined number of pattern images of the object exposed to the different types of pattern lights; binarizing the pattern images; generating a space code from the binarized pattern images; generating a space code image based on the space code; converting 2-dimensional coordinates corresponding to pixels constituting the space code image to 3-dimensional coordinates using a 3-dimensional coordinate conversion equation; calculating a distance from the object using the 3-dimensional coordinates and the 3-dimensional coordinate conversion equation; and generating a depth image by reflecting the distance to the space code image.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a configuration of a mobile terminal for generating a 3-dimensional image according to an exemplary embodiment of the present invention;

FIG. 2 illustrates a method for generating a 3-dimensional image according to an exemplary embodiment of the present invention;

FIG. 3 illustrates pattern images of an object that are picked up when the object exposed to different pattern lights according to an exemplary embodiment of the present invention;

FIG. 4 illustrates a space code image obtained by binarizing pixels of the pattern images of FIG. 3;

FIG. 5 illustrates a depth image obtained by reflecting a distance from the object to the space code image of FIG. 4;

FIG. 6 illustrates a 3-dimensional modeling image generated by performing 3-dimensional modeling on a depth image according to an exemplary embodiment of the present invention; and

FIG. 7 illustrates a 3-dimensional image generated performing texture mapping on a 3-dimensional modeling image according to an exemplary embodiment of the present invention.

### DETAILED DESCRIPTION OF THE INVENTION

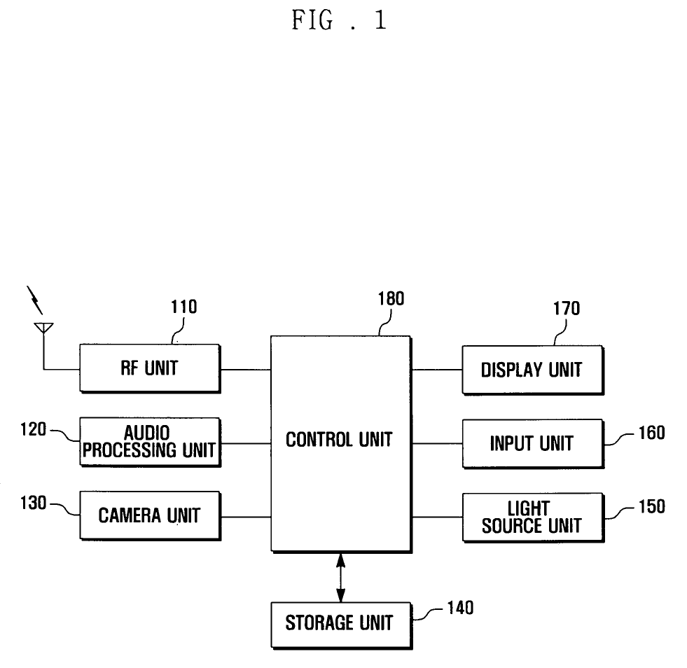

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably, arranged mobile terminal. In the following description, the term “space code” denotes a code value used for creating a space code image. A pattern light is projected to a object a predetermined number of times such that the camera module of the mobile terminal picks up as many images as the number of the pattern light projections, binarizes the pattern images, discriminates black (0) and white (1) pixels that constitute the binarized pattern images, and generates a space code composed of “0” and “1” digits. For instance, when the pattern light projected to the object 8 times, 8 pattern images are acquired. In this case, the mobile terminal determines whether the 8 pixels at the same position of the 8 individual pattern images is black or white, and assigns 0 to the black pixels and 1 to the white pixels so as to generate an 8-digit binary code.

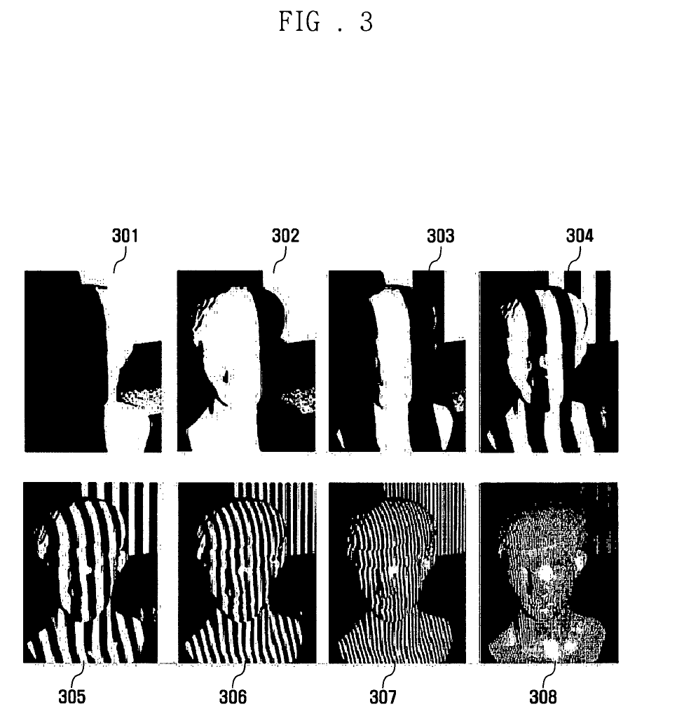

In the following description, the term “pattern light” is the light projected by a light source of the mobile terminal to pick up the pattern images. The pattern light is projected a predetermined number of times in order for the camera module to pick up the images of the same object as many as the number of pattern light projections. The pattern light has a pattern of light (1) and darkness (0) stripes alternating in a predetermined direction. FIG. 3 shows the images of the object that are picked up while exposed to the pattern light. In the first image of FIG. 3, the left side of the object is exposed to the darkness of the pattern light, and the right side of the object is exposed to the light of the pattern light. In an exemplary embodiment of the present invention, an inverse pattern light can be projected to the object. For instance, the mobile terminal can project the light patterned in order of light (1) and darkness (0) and then the light patterned in order of darkness (0) and light (1). By using the two images picked up with the oppositely patterned lights, it is possible to define the boundary line between regions exposed to the light (1) and darkness (0) accurately. From the point of reference of the boundary, the image in which the left side is exposed to the darkness (0) and right side exposed to the light (1) are compensated so as to generate a compensated pattern image. In case of using the inverse pattern light additionally, the number of pattern light projections increases twice.

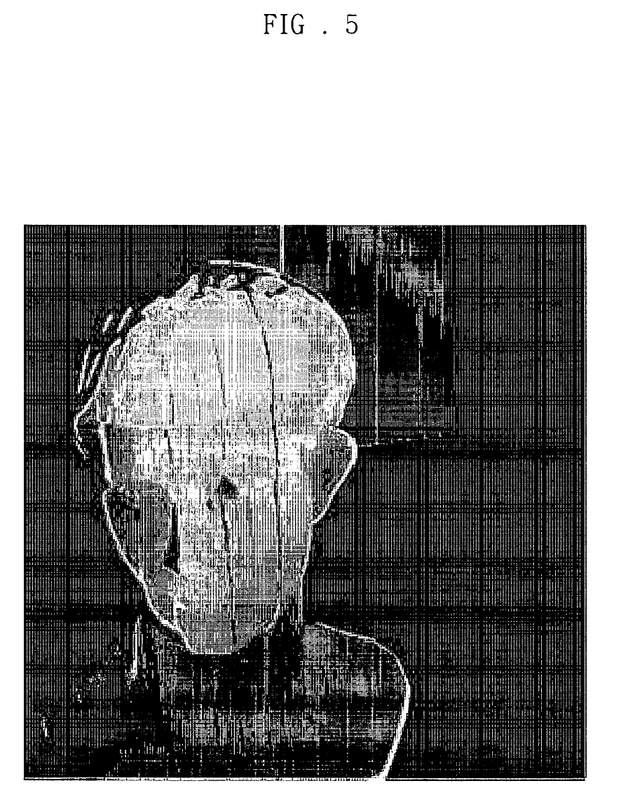

In the following description, the term “space code image” denotes an image generated by using the space code. The space code is composed of the digits as much as the number of the pattern light projections. For instance, if 8 pattern images are acquired by projecting the pattern light 8 times, the space code is an 8-digit binary code. This means that each pixel of the pattern image is represented by an 8-digit binary code, and the binary code is converted into a decimal number. For instance, a pixel is represented by the space code ‘01010011’, the space code is converted to the decimal number of 83. A pixel has a degree of brightness ranging from black to white and the brightness degree is represented by one of the 256 values from ‘0’ to ‘255’. Accordingly, the pixel represented by the decimal number of ‘83’ has the corresponding brightness. In this manner, all the pixels of the pattern image are expressed with the decimal numbers of corresponding brightness degrees. The image created with the pixels represented by the corresponding brightness degrees is called a space code image. FIG. 5 shows an exemplary space code image.

In the following description, the term “3-dimensional coordinate conversion equation” denotes an equation for generating 3-dimensional coordinates. The 3-dimensional coordinate conversion equation is derived from a camera matrix calculated with a camera calibration and a projector matrix calculated with a projector calibration. The 3-dimensional coordinate conversion equation can be set by the user or a default configuration of the mobile terminal. The 3-dimensional coordinate conversion equation can be received from outside and stored in the mobile terminal. Each pixel of the space code image has 2-dimensional coordinates and the 2-dimensional coordinates can be converted to 3-dimensional coordinates by using the 3-dimensional coordinate conversion equation.

In the following description, the term “depth image” denotes an image obtained by reflecting the data of distance from the object to the space code image. The depth image becomes brighter as the distance from the object decreases and becomes darker as the distance from the object increases. After creating the depth image, the mobile terminal performs a 3-dimensional modeling on the depth image to generate a 3-dimensional modeling image.

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the object matter of the present invention.

In the exemplary embodiment of the present invention, the 3-dimensional image generation method is directed to a mobile terminal, but the present invention is applicable to all the forms of image processing devices. The mobile terminal can be one of a Portable Multimedia Player (PMP), a Personal Digital Assistant (PDA), a Smartphone, an MP3 player, and their equivalents that are equipped with an image processing module.

FIG. 1 illustrates a configuration of a mobile terminal for generating a 3-dimensional image according to an exemplary embodiment of the present invention.

As shown in FIG. 1, the mobile terminal according to an exemplary embodiment of the present invention includes a Radio Frequency (RF) unit 110, an audio processing unit 120, a camera unit 130, a storage unit 140, a light source unit 150, an input unit 160, a display unit 170, and a control unit 180.

The RF unit 110 is responsible for transmitting and receiving radio signals carrying data. The RF unit 110 includes an RF transmitter for up-converting and amplifying the transmission signal and an RF receiver for low noise amplifying and down-converting the received signal. The RF unit 110 also outputs the data carried by the received signal to the control unit 180 and transmits the data output by the control unit 180 on a radio channel through an antenna. Particularly in an exemplary embodiment of the present invention, the RF unit 110 can receive the signal carrying the data related to the 3-dimensional coordinate conversion equation. The 3-dimensional coordinate conversion equation can changed depending on the configuration of the mobile terminal, and the control unit 180 can control the mobile terminal to receive the data related to the 3-dimensional coordinate conversion equation from a web server by means of the RF unit 110.

The audio processing unit 120 includes at least one codec, such as a data codec for processing packet data signal and an audio codec for processing audio signal including voice. The audio processing unit 120 converts a digital audio signal to an analog audio signal by means of the audio codec and outputs the converted analog audio signal through a speaker (SPK) in the form of an audible sound, and converts the analogue audio signal input through a microphone (MIC) to a digital audio signal by means of the audio codec. In an exemplary embodiment of the present invention, the audio processing unit 120 can be configured to output a sound effect alerting the image capture operation of the camera unit 130. Since a 3-dimensional image is generated with multiple image capture times, the audio processing unit 120 allows the user to be aware of the start and end of the image-taking actions with the sound effect.

The camera unit 130 picks up the image of an object and includes a camera sensor that converts an optical signal to an electric signal and a signal processor that converts the analog image data into digital image data. The camera sensor can be implemented with one of Charge Coupled device and complementary metal-oxide-semiconductor (CMOS), and the signal process can be a Digital Signal Processor (DSP). The camera sensor and the image processor can be implemented as an integrated device or two separate devices. In an exemplary embodiment of the present invention, the camera unit 130 picks up the image of the object exposed to the pattern light or a gradation light. In an exemplary embodiment of the present invention, the camera unit 130 can pick up the image of the object in a normal image pickup mode. The normal image pickup mode means an operation mode in which the pattern light or the gradation light is not projected to the object, and the image picked up in the normal image pickup mode is used for texture mapping for presenting the texture and color of the object.

The storage unit 140 stores an operating system, application programs and data for executing the operation of the mobile terminal. The storage unit 140 can be divided into a program region and a data region. Particularly in an exemplary embodiment of the present invention, the storage unit 140 stores the application program for generating the 3-dimensional images. The storage unit 140 also stores the data related to the 3-dimensional coordinate conversion equation. There can be multiple 3-dimensional coordinate conversion equations stored in the storage unit 140. The storage unit 140 also stores the images picked up in the normal image pickup mode and a pattern light or gradation light-assistant image pickup mode.

The light source unit 150 is capable of projecting light to the object to be picked up and can be implemented with a projector. Although the following description is made under the assumption that the light source unit 150 is implemented with the project, the present invention is not limited thereto. For example, the light source unit 150 can be implemented with one of various types of light emission device. In an exemplary embodiment of the present invention, the light source unit 150 projects the pattern light to the object to be picked up by the camera unit 130. In an exemplary embodiment of the present invention, the light source unit 150 projects the gradation light to the object to be picked up by the camera unit 130. In an exemplary embodiment of the present invention, the light source unit 150 can be used to project an image stored in the storage unit 140 on a screen under the control of the control unit 180.

The input unit 160 generates a key signal corresponding to the key selected by the user and transfers the key signal to the control unit 180. The input unit 160 can be implemented with a keypad or a touchpad including a plurality of alphanumeric and function keys. In case that the mobile terminal is provided with an image sensor and/or acceleration sensor, these sensors can be used as the parts of the input unit 160.

The display unit 170 can be implemented with a Liquid Crystal Display (LCD) and displays the menus of the mobile terminal, user input data, operation states of functions, and other configured information in the form of visual images. For instance, the display unit 170 displays booting progress of the mobile terminal, idle mode screen, indicators, call progress, and application execution screens. Particularly in an exemplary embodiment of the present invention, the display unit 170 displays the image picked up by the camera unit 130. The display unit 170 can display the images picked up in the normal image pickup mode and the pattern light-assistant image pickup mode. The display unit 170 also can display the space code image generated under the control of the control unit 180. The display unit 170 also can display the depth image obtained by reflecting the distance from the object to the space code image. The display unit 170 also can display the 3-dimensional modeling image and the image obtained by performing the texture mapping on the 3-dimensional modeling image.

The control unit 180 controls the entire operations of the mobile terminal and signaling among the internal function blocks of the mobile terminal. In an exemplary embodiment of the present invention, the control unit includes an image processor. The image processor is responsible for processing the images input to the control unit 180, i.e., encoding and decoding the input images. The image processor can be provided with an image codec to compress raw image data and decompress compressed image data according to an image data format.

Particularly, in an exemplary embodiment of the present invention, the control unit 180 controls the light source unit 150 to project the pattern light or the gradation light to the object to be picked up by the camera unit 130. The control unit 180 controls the camera unit 130 to picks up the image of the object exposed to the pattern light or the gradation light projected by the light source unit 150. The control unit 180 analyzes the pixels constituting the object image and output the visual data in the form of binary space codes. The control unit 180 converts the binary space codes to the decimal numbers and assigns the brightness levels corresponding to the decimal numbers (among 256 brightness levels) so as to create a space code image composed of the brightness-leveled pixels. The control unit 180 also converts the coordinates of the individual pixels of the space code image to 3-dimensional coordinates using the 3-dimensional coordinate conversion equation. The control unit 180 generates a depth image using the 3-dimensional coordinates corresponding to the individual pixels. The control 180 can calculate the distance from the object of the image using the converted 3-dimensional coordinates and the camera matrix when generating depth image. The control unit 180 reflexes the distance from the object to the space code image to create the depth image.

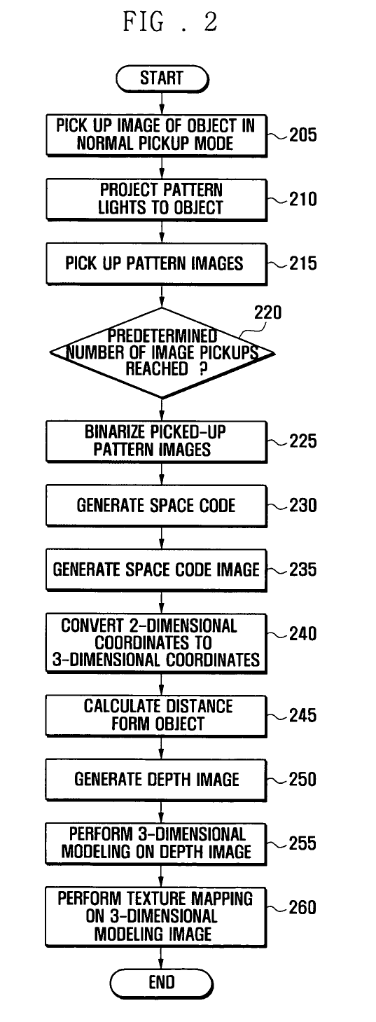

FIG. 2 illustrates a method for generating a 3-dimensional image according to an exemplary embodiment of the present invention.

Referring to FIG. 2, the control unit 180 of the mobile terminal controls the camera unit 130 to pick-up images of an object in the normal image pickup mode (block 205). In the normal image pickup mode, the camera unit 130 picks up the image only with the natural light or the light projected by a flash of the mobile terminal without projection of the pattern light or the gradation light. The image picked up in the normal image pickup mode is used to reflect the texture and color of the object to the 3-dimensional modeling image created afterward. A number of normal image taking times can be changed depending on the configuration, and the control unit 180 controls display unit 170 to display a dialog window prompting to select one of the images picked up in the normal image pickup mode. If an image picked up in the normal image pickup mode is too much dark or bright, it may be difficult to obtain the texture and color of the object from the normal image, and thus it is preferred to picks up multiple normal images and select a best image to apply the correct texture and color of the object to the 3-dimensional image.

After taking the normal image of the object, the control unit 180 controls the light source unit 150 to project the pattern light (block 210). The pattern light includes a pattern to generate the space code and is projected to the object a predetermined number of times. The pattern of the pattern light is formed with the light (1) and darkness (0) stripes alternating in horizontal or vertical direction. FIG. 3 shows the images of the object that are picked up while exposed to the pattern light. In the first image of FIG. 3, the left side of the object is exposed to the darkness of the pattern light, and the right side of the object is exposed to the light of the pattern light. In an exemplary embodiment of the present invention, an inverse pattern light can be projected to the object. For instance, the mobile terminal can project the light patterned in order of light (1) and darkness (0) from left to right and then the light patterned in order of darkness (0) and light (1) from left to right. If the object includes a shadow area, the shadow area can be presented in darkness even with the exposure to the light (1). In this case, the boundary between the light-exposed area and the darkness-exposed area is likely to become ambiguous. This boundary ambiguity causes the problem to acquire a correct 3-dimensional image. Accordingly, in order to define the accurate between the light-exposed area and the darkness-exposed are, two images of the object are picked up with the normal pattern light and the inverse pattern light in which the alternating or the or the light and darkness stripes are inversed. At this time, the control unit 180 overlaps the two object images picked up with the pattern lights having opposite patterns and compensate the boundary on the first object image, thereby acquiring an accurate 3-dimensional image. In an exemplary embodiment of the present invention, the control unit 180 can control the light source unit 150 to project a gradation light in which the brightness of the light is gradually darkened in a direction to the object.

The control unit 180 controls the camera unit 130 to pick up the image of the object on which the pattern light is projected (block 215). Next, the control unit 180 counts a number of patterned image pickup times and determines whether the number of patterned image pickup times reaches a predetermined number of times (block 220). The patterned images are picked up to generate a space code, and the space code is obtained from a plurality of images picked up with different pattern lights. The control unit 180 controls the camera unit 130 to take the image of the object repeatedly in synchronization with the projection of the different pattern lights until the number of patterned image pickup times reaches the predetermined number of times. The pattern of the light projecting to the object is changed whenever the patterned image is picked up.

The first image 301 of FIG. 3 is a patterned image picked up with a level 1 pattern of one darkness stripe (0) and one light stripe (1), and the eighth image 308 of FIG. 3 is a patterned image picked up with a level-8 pattern of 256 darkness and light stripes. The control unit 180 controls such that the pattern lights having differently alternating darkness and light stripe patterns in series.

If the countered number reaches the predetermined number of the patterned image pickup times, the control unit 180 binarizes the picked-up pattern images (block 225). The binarization is a process to convert a color image to a black and white image. The control unit 180 measures the brightness of the pixels and compares the brightness of each pixel with a threshold value in the range of black (0) to white (block 255). If the brightness of the pixel is greater than the threshold value, the pixel is presented in white and, otherwise, in black. For example, if the threshold value is set to 128, the control unit 180 controls such that the pixel having the brightness level in the range from ‘0’ to ‘127’ is presented in black and the pixel having the brightness level in the range from ‘128’ to ‘255’ is presented in white.

After the binarization of the picked-up images, the control unit 180 generates a space code of the binarized images (block 230). The space code is a binary code that includes code values for use of generation of a space code'image. A space code value is composed of a number of digits as many as the number of images picked with the pattern lights, the space code value determines whether the corresponding pixel is black (0) or white (1). In the exemplary case of FIG. 3, the control unit 180 controls the light source unit 150 to project the pattern light 8 times with different patterns and controls the camera unit 130 to pick up the images of the object exposed to the pattern light. Assuming that each image has resolution of 300*400 pixels, the control unit 180 checks the color of the pixel at coordinates (100, 250) of individual images. If the same pixel is black (0) in the first image 301, white (1) in the second image 302, white (1) in the third image 303, black (0) in the fourth image 304, white (1) in the fifth image 305, white (1) in the sixth image 306, white (1) in the seventh image 307, and black (0) in the eighth image 308, the space code value at the pixel becomes ‘01100001’. In this manner, all the space code values at the entire pixels are calculated to generate a space code.

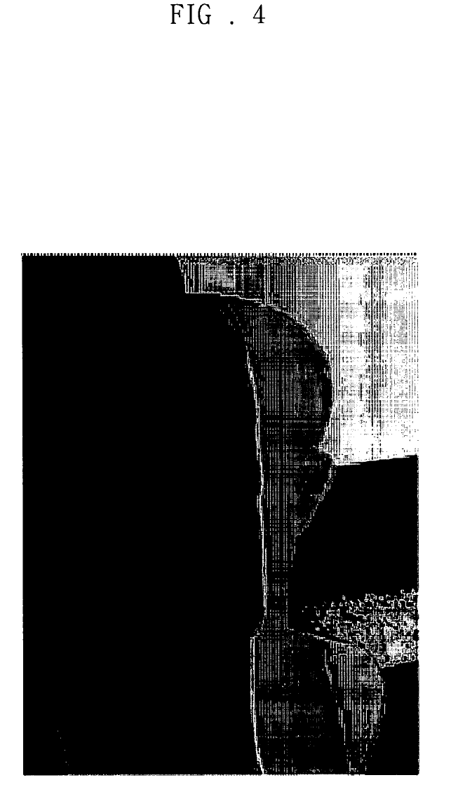

After generating the space code, the control unit 180 creates a space code image using the space code (block 235). In order to generates the space code image, the decimal numbers corresponding to the space code values at the individual pixels. In case that the space code value is composed of 8 digits, the control unit 180 converts the 8-digit space code value of each pixel to a decimal number. For example, the space code value ‘01100001’ is converted into a decimal number ‘97’. When using the brightness scale of 256 levels from ‘0’ to ‘255’, the control unit 180 presents the pixel with the brightness level corresponding to the decimal number. The brightness presentation is performed to all the pixels of the image so as to generate a space code image. FIG. 4 shows an exemplary space code image generated in the aforementioned manner. The space code image of FIG. 4 is formed by applying the brightness levels corresponding to the space code values to individual pixels. In case using the gradation light, the control unit 180 controls the camera unit 130 to pick-up the image of the object exposed to the gradation light at a time and generates the space code image by binarizing the single picked-up image.

The control unit 180 converts the coordinates constituting the space code image to 3-dimensional coordinates using the 3-dimensional coordinate conversion equation (block 240). The 3-dimensional coordinate conversion equation can be configured by the user or the default setting of the mobile terminal. The control unit 180 also can download the 3-dimensional coordinate conversion equation from a web server by means of the RF unit 110 and configures the mobile terminal with the downloaded 3-dimensional coordinate conversion equation. The 3-dimensional coordinate equation is used to convert the 2-dimensional coordinates of an image frame into 3-dimensional coordinates for the reality of the image. The 3-dimensional coordinate conversion equation can be changed in data depending on the configuration of the mobile terminal. In the default setting, the 3-dimensional image conversion equation is configured with the data optimized for acquiring the most accurate 3-dimensional image. The mobile terminal can store multiple 3-dimensional coordinate conversion equations such that the user to select one of the 3-dimensional coordinate conversion equations to convert the 2-dimensional coordinates to the 3-dimensional coordinates.

In case that the mobile terminal is implemented with the camera unit 130 and the light source unit 150 that are changeable in position, the same 3-dimensional coordinate equation has to be changed as the distance between the camera unit 130 and the light source unit 150 changes. At this time, the user can configure the 3-dimensional coordinate conversion equation manually. In order to configure the 3-dimensional coordinate conversion equation manually, a reference object is needed. In some embodiments, a calibration box is used as the reference object. The calibration box includes n reference points, and it is assumed that the real word coordinates (xw1, yw1, zw1) of the n reference points are known. In the following, it is assumed that the calibration box has 12 reference points and the real world coordinates (xw1, yw1, zw1) of the 12 reference points are known.

The control unit 180 controls the light source unit 150 to project the pattern lights to the reference object and the camera unit 130 to pick up the patterned images of the reference object exposed to the pattern lights. Next, the control unit generates a space code image using the patterned images and substitutes the image frame coordinates (xc1, yc1) of the space code image for the real world coordinates (xw1, yw1, zw1) of Equation 1

$$( \begin{matrix}{h}_{c} {x}_{c} \\ {h}_{c} {y}_{c} \\ {h}_{c }\end{matrix} ) = [ \begin{matrix}{c}_{11} & {c}_{12} & {c}_{13} & {c}_{14} \\ {c}_{21} & {c}_{22} & {c}_{23} & {c}_{24} \\ {c}_{31} & {c}_{32} & {c}_{33} & {c}_{34}\end{matrix} ] ( \begin{matrix}{x}_{w} \\ {y}_{w} \\ {z}_{w} \\ 1\end{matrix} ) \qquad [ Eqn 1 ]$$

where h_{c} is a 3-dimensional conversion constant. By substituting the 12 real world coordinates (xw1, yw1, zw1) for x_{w}, y_{w}, and z_{w} and substituting the image frame coordinates (xc1, yc1) for x_{c} and y_{c}, the values of c₁₁ to c₃₄ can be obtained. The camera matrix is a matrix composed of c₁₁ to c₃₄. In the same manner, the projector matrix is obtained by substituting the image frame coordinate (xp2) and real world coordinates (xw2, yw2, zw2) for the corresponding elements of Equation 2:

$$( \begin{matrix}{h}_{p} {x}_{p} \\ {h}_{p} \end{matrix} ) = [ \begin{matrix}{p}_{11} & {p}_{12} & {p}_{13} & {p}_{14} \\ {p}_{21} & {p}_{22} & {p}_{23} & {p}_{24}\end{matrix} ] ( \begin{matrix}{x}_{w} \\ {y}_{w} \\ {z}_{w} \\ 1\end{matrix} ) \qquad [ Eqn . 2 ]$$

where hₚ is a 3-dimensional conversion constant. By substituting the image frame coordinate (xp2) for xₚ and the real world coordinates (xw2, yw2, zw2) for x_{w}, y_{w}, and z_{w} the values of p₁₁ to p₂₄ can be obtained. The projector matrix is a matrix composed of p₁₁ to p₂₄.

Solving by eliminating h_{c} and hₚ from the relation of Equation 1 and Equation 2, Equation 3 is derived:

$$[ \begin{matrix}{c}_{11} - {c}_{31} {x}_{c} & {c}_{12} - {c}_{32} {x}_{c} & {c}_{11} - {c}_{33} {x}_{c} \\ {c}_{21} - {c}_{31} {y}_{c} & {c}_{22} - {c}_{32} {y}_{c} & {c}_{23} - {c}_{33} {y}_{c} \\ {p}_{11} - {p}_{21} {x}_{p} & {p}_{12} - {p}_{22} {p}_{13} & {p}_{13} - {p}_{23} {x}_{p}\end{matrix} ] \times {( \begin{matrix}{x}_{w} & {y}_{w} & {z}_{w}\end{matrix} )}^{T} = ( \begin{matrix}{c}_{34} {x}_{c} - {c}_{14} \\ {c}_{34} {y}_{c} - {c}_{24} \\ {p}_{24} {x}_{p} - {p}_{14}\end{matrix} ) \qquad [ Eqn . 3 ]$$

where V=(x_{w} y_{w} z_{w})^{T} is defined and, if Q and F are defined as Equations 4 and 5, the entire equation can be expressed as Equation 6. The values of c₁₁ to c₃₄ and p₁₁ to p₂₄ preset, and the value of x_{w}, y_{w}, and z_{w} can be obtained by substituting the coordinates of the individual pixels of the space code image and the coordinates x_{c}, y_{c}, and xₚ as the coordinates of the pattern light-exposed object image frame to the Equation 6. Here, Equation 6 is the 3-dimensional coordinate conversion equation according to an exemplary embodiment of the present invention.

$$\begin{matrix}Q = [ \begin{matrix}{c}_{11} - {c}_{31} {x}_{c} & {c}_{12} - {c}_{32} {x}_{c} & {c}_{11} - {c}_{33} {x}_{c} \\ {c}_{21} - {c}_{32} {y}_{c} & {c}_{22} - {c}_{32} {y}_{c} & {c}_{23} - {c}_{33} {y}_{c} \\ {p}_{11} - {p}_{21} {x}_{p} & {p}_{12} - {p}_{22} {p}_{13} & {p}_{13} - {p}_{23} {x}_{p}\end{matrix} ] & [ Eqn . 4 ] \\ F = ( \begin{matrix}{c}_{34} {x}_{c} - {c}_{14} \\ {c}_{34} {y}_{c} - {c}_{24} \\ {p}_{24} {x}_{p} - {p}_{14}\end{matrix} ) & [ Eqn . 5 ] \\ V = {Q}^{- 1} \times F & [ Eqn . 6 ]\end{matrix}$$

After converting the 2-dimensional coordinates to the 3-dimensional coordinates, the control unit 180 calculates the distance between the image frame and the object (block 245). In order to calculate the distance from the object, the camera matrix and the real world 3-dimensional coordinates. The distance between the image frame and the object is calculated as equation 7. The camera matrix uses the matrix of Equation 1, and the real world 3-dimensional coordinates uses the value of V obtained by Equation 6.

$$d = \frac{\vert {c}_{31} {x}_{w} + {c}_{32} {y}_{w} + {c}_{33} {z}_{w} + {c}_{34} \vert}{\sqrt{{c}_{31}^{2} + {c}_{32}^{2} + {c}_{33}^{2}}} \qquad [ Eqn . 7 ]$$

The control unit 180 substitutes the 3-dimensional coordinates for the corresponding elements of equation 7 to obtain the distance d between the image frame and the object and reflects the distance d to the 2-dimensional coordinates.

Next, the control unit 180 creates a depth image using the distance d between the image frame and the object (block 250). The depth image is created by reflecting the distance d between the image frame and the object to the space code image. Typically, as the distance d between the image frame and the object decreases, the image is brightened; and as the distance d between the image frame and the object increases, the image is darkened. FIG. 5 shows a depth image obtained by reflecting the distance d between the image frame and the object to the space code image of FIG. 4. As compared to FIG. 4, the depth image of FIG. 5 gives depth perception.

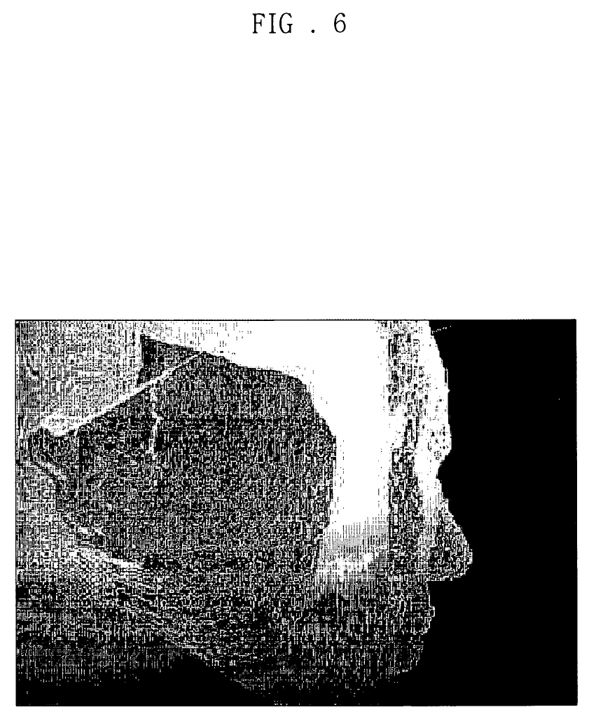

Next, the control unit 180 performs 3-dimensional modeling on the depth image (block 255). The 3-dimensional modeling is performed using functions included in a graphics library. Typically, the graphics library is the Open Graphics Library (OpenGL). The graphics library is stored in the storage unit 140 of the mobile terminal, and the control unit 180 performs the 3-dimensional modeling on the depth image obtained by reflecting the distance d between the image frame and the object using the functions included in the graphics library stored in the storage unit 140. FIG. 6 shows the image obtained by performing the 3-dimensional modeling on the depth image.

Finally, the control unit 180 performs texture mapping on the image obtained by perform the 3-dimensional modeling (block 260). The texture mapping is the process for reflecting the texture and color obtained from the image picked up in the normal image pickup mode at block 205 to the 3-dimensional modeling image. Consequently, the control unit 180 creates the 3-dimensional image and controls the display unit 170 to display the 3-dimensional image.

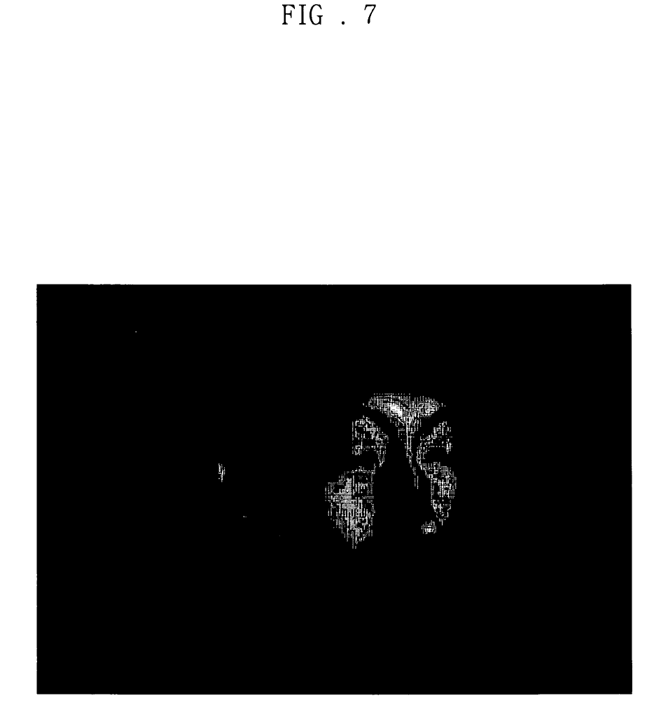

FIG. 7 shows the 3-dimensional image that is finally acquired by performing the texture mapping. As shown in FIG. 7, the 3-dimensional has the skin color and texture.

As described above, the 3-dimensional image generation method is advantageous for the user to generate a 3-dimensional image by using a mobile terminal. Since the 3=dimensional image generated by the mobile terminal can be used in various applications, thereby improving the usability of mobile terminal.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A mobile terminal comprising:
a light source unit configured to project pattern lights to an object;
a camera unit configured to pick-up images of the object exposed to the pattern lights; and
a control unit configured to:
generate a space code from at least one of images picked up the camera,
generate a space code image based on the space code,
convert 2-dimensional coordinates of the space code image to 3-dimensional coordinates using a 3-dimensional coordinate equation, and
generate a depth image using the 3-dimensional coordinates.

2. The mobile terminal of claim 1, wherein the light source unit is configured to project a gradation light of which brightness varies gradually in a direction.

3. The mobile terminal of claim 1, wherein the camera unit is configured to pick-up the image of the object whenever the object is exposed to the pattern light projected by the light source unit.

4. The mobile terminal of claim 1, wherein the control unit is configured to calculate a distance from the object using the 3-dimensional coordinates and a camera matrix.

5. The mobile terminal of claim 1, further comprising a radio frequency unit configured to receive data of the 3-dimensional coordinate conversion equation.

6. The mobile terminal of claim 1, further comprising a display unit configured to display the depth image.

7. The mobile terminal of claim 1, further comprising a memory configured to store the depth image.

8. A 3-dimensional image generation method of a mobile terminal, the method comprising:
projecting different types of pattern lights to an object in series,
picking up a predetermined number of pattern images of the object exposed to the different types of pattern lights;
binarizing the pattern images;
generating a space code from the binarized pattern images;
generating a space code image based on the space code;
converting 2-dimensional coordinates corresponding to pixels constituting the space code image to 3-dimensional coordinates using a 3-dimensional coordinate conversion equation;
calculating a distance from the object using the 3-dimensional coordinates and the 3-dimensional coordinate conversion equation; and
generating a depth image by reflecting the distance to the space code image.

9. The method of claim 8, further comprising a receiving data of the 3-dimensional coordinate conversion equation.

10. The method of claim 8, further comprising displaying the depth image.

11. The method of claim 8, storing the depth image in a memory.

12. An apparatus for use in a mobile terminal, the apparatus comprising:
a light source unit configured to project pattern lights to an object;
a camera unit configured to pick-up images of the object exposed to the pattern lights; and
a control unit configured to:
generate a space code from at least one of images picked up the camera,
generate a space code image based on the space code,
convert 2-dimensional coordinates of the space code image to 3-dimensional coordinates using a 3-dimensional coordinate equation, and
generate a depth image using the 3-dimensional coordinates.

13. The apparatus of claim 12, wherein the light source unit is configured to project a gradation light of which brightness varies gradually in a direction.

14. The apparatus of claim 12, wherein the camera unit is configured to pick-up the image of the object whenever the object is exposed to the pattern light projected by the light source unit.

15. The apparatus of claim 12, wherein the control unit is configured to calculate a distance from the object using the 3-dimensional coordinates and a camera matrix.

16. The apparatus of claim 12, wherein the control unit is configured to receive data of the 3-dimensional coordinate conversion equation via a radio frequency unit of the mobile terminal.

17. The apparatus of claim 12, wherein the control unit is configured to cause a display unit to display the depth image.
